(19) United States
(12) Patent Application Publication
(10) Pub. No.: US 2015/0039637 A1
(43) Pub. Date: Feb. 5, 2015

(54) Systems Apparatus and Methods for Determining Computer Apparatus Usage Via Processed Visual Indicia

(71) Applicant: The Nielsen Company (US), LLC, Schaumburg, IL (US)

(72) Inventors: Alan Neuhauser, Silver Spring, MD (US); John Stavropoulos, Edison, NJ (US)

(21) Appl. No.: 13/955,163

(22) Filed: Jul. 31, 2013

(51) Int. Cl. G06F 17/30

(52) U.S. Cl. CPC G06F 17/30253
USPC 707/758

(57) ABSTRACT

A computer-implemented apparatus, system and method to determine usage of a processing device, such as a cell phone, tablet, laptop, personal computer, etc. and/or to determine media exposure on a processing device. Screenshot images from the device are received and processed to form a feature map, where image characteristics are extracted from the feature map. These characteristics are then used to determine the presence of text and consequently extract text from the screenshot image. The text is then collected and compared to a library of text that is linked to specific device uses (e.g., software application, format) or specific media (e.g., artist, song, file name). Matches are then logged and used to generate audience measurement reports.

### TECHNICAL FIELD

The present disclosure is directed to monitoring processor-based devices, such as cell phones, computer tablets, personal computers, laptops, and the like for device usage. More specifically, the present disclosure is directed to visually monitoring screens of devices to determine usage and/or media exposure.

### BACKGROUND INFORMATION

Monitoring device usage and media exposure has long been an important feature for audience measurement and data collection entities. To date, various configurations and techniques have been developed in order to track application and/or software usage, accessed device features, web data, media exposure, game play, etc. While these configurations have experienced different degrees of success, one issue with such systems is that the monitoring software, which typically resides on the device, must be directly interfaced with the device's operating system and/or other applications, and may also require interfacing with communication modules to track call, data and/or Internet usage.

One of the drawbacks of such configurations is that the interface of the monitoring software with the operating systems/applications requires complex software to ensure that data collection is compatible and accurate. In the cases of different platforms (e.g., Windows, Linux, MacOS, Android, etc.), different versions of the same software must be written and tested. Additionally, at least some platforms (e.g., Android) may restrict the types of data that may be monitored, as well as the manner of collection, by audience measurement and data collection entities.

With regard to monitoring media exposure, such as tracking exposure to audio, video, web pages and the like, additional software may be required to determine media exposure and/or consumption. In some cases, sophisticated audio and/or video processing techniques may be required in order to transform audio/video into data form. For example, audio signatures or “fingerprints” may be generated by transforming audio portions of media into the frequency domain and subsequently using spectral components of the transformed audio as identifiable characteristics. Some commercially available examples include those by Shazam, SoundHound, Gracenote, MusicBrainz and others. Alternately, audio or video encoding may be used to embed ancillary codes into audio/video portions of the media, where the user device decodes and detects the ancillary codes. These codes are then used to identify characteristics of the media for media exposure and/or data collection purposes.

While these and other techniques are effective at determining media exposure, they are unduly complex to implement in practice. What is needed is a configuration that is capable of monitoring device usage and/or monitor media exposure that is easier to use and implement on devices across a wide variety of platforms.

### SUMMARY

Accordingly, apparatuses, systems and methods are disclosed where, under one embodiment, a computer-implemented method for monitoring at least one of usage and media exposure on a processing device is disclosed, comprising the steps of: receiving a screenshot image of the processing device; processing the screenshot image via a processing apparatus to detect at least one text region in the screenshot image and to extract text from the at least one text region; comparing the extracted text, via the processing apparatus, with stored text to determine if a match exists, wherein the stored text is associated with a processing device characteristic; and identifying at least one of a specific usage and media exposure via the processing apparatus if a match is determined to exist.

Under another exemplary embodiment, a computer program product is disclosed, comprising a computer usable medium having a computer readable program code embodied therein, said computer readable program code adapted to be executed to implement a method for method for monitoring at least one of usage and media exposure on a processing device, said method comprising: receiving a screenshot image of the processing device; processing the screenshot image via a processing apparatus to detect at least one text region in the screenshot image and to extract text from the at least one text region; comparing the extracted text, via the processing apparatus, with stored text to determine if a match exists, wherein the stored text is associated with a processing device characteristic; and identifying at least one of a specific usage and media exposure via the processing apparatus if a match is determined to exist.

Under yet another exemplary embodiment, a computer-implemented method is disclosed for monitoring at least one of usage and media exposure on a processing device, comprising the steps of: generating a feature map via a processing apparatus from a screenshot image of the processing device; extracting image characteristics via the processing apparatus from the feature map; detecting at least one text region via the processing apparatus based on the extracted characteristic; extracting text from the at least one text region via the processing apparatus; comparing the extracted text, via the processing apparatus, with stored text to determine if a match exists, wherein the stored text is associated with a processing device characteristic; and identifying at least one of a specific processor device usage and media exposure via the processing apparatus if a match is determined to exist.

### BRIEF DESCRIPTION OF THE DRAWINGS

The present invention is illustrated by way of example and not limitation in the figures of the accompanying drawings, in which like references indicate similar elements and in which:

FIG. 1 illustrates an exemplary block diagram of a processing device utilized in the present disclosure;

FIG. 2 illustrates an exemplary process for screenshot image processing under one embodiment;

FIG. 2A illustrates an exemplary image segmentation arrangement for the embodiment of FIG. 2;

FIG. 3 illustrates an exemplary text extraction process under one embodiment;

FIG. 4 illustrates another exemplary text extraction process under another embodiment;

FIG. 5 illustrates an exemplary process for determining device usage and/or media exposure utilizing embodiments disclosed above in connection with FIGS. 1-4; and

FIG. 6 discloses an exemplary embodiment for structuring text for matching processes.

### DETAILED DESCRIPTION

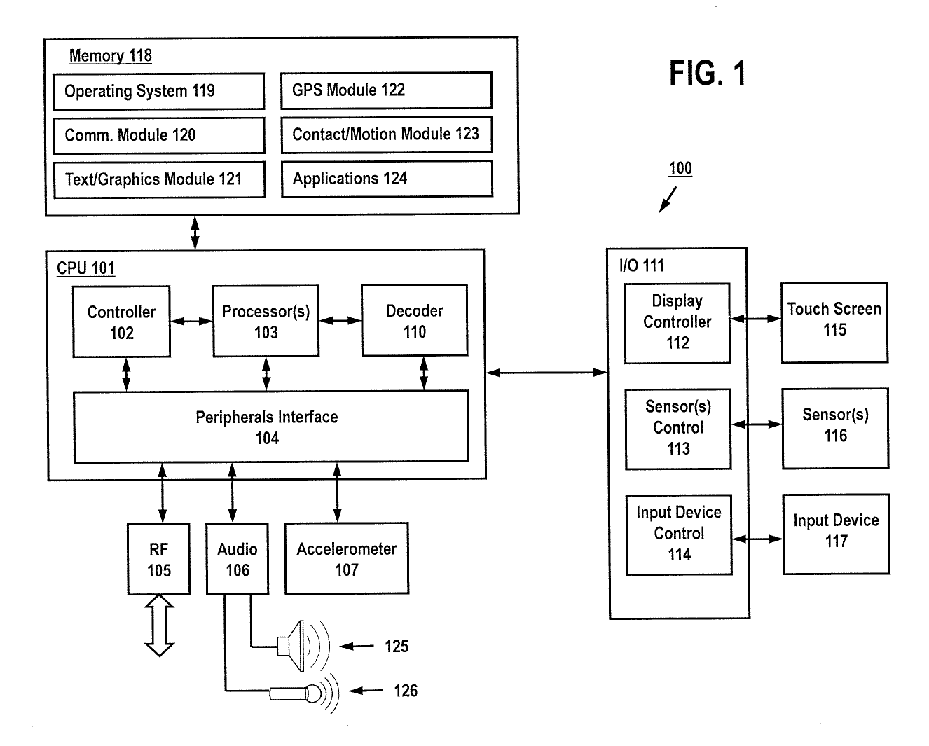

FIG. 1 is an exemplary embodiment of a processing device 100 (which may also be referred to herein as a “portable processing device” or “computing device”) which may function as a mobile terminal, and may be a smart phone, laptop, personal computer, tablet computer, or the like. Device 100 may include a central processing unit (CPU) 101 (which may include one or more computer readable storage mediums), a memory controller 102, one or more processors 103, a peripherals interface 104, RF circuitry 105, audio circuitry 106, a speaker 125, a microphone 126, and an input/output (I/O) subsystem 111 having display controller 112, control circuitry for one or more sensors 113 and input device control 114. These components may communicate over one or more communication buses or signal lines in device 100. It should be appreciated that device 100 is only one example of a portable processing device, and that device 100 may have more or fewer components than shown, may combine two or more components, or a may have a different configuration or arrangement of the components. The various components shown in FIG. 1 may be implemented in hardware or a combination of hardware and software, including one or more signal processing and/or application specific integrated circuits.

In one embodiment, decoder 110 serves to decode ancillary data embedded in audio signals in order to detect exposure to media. Examples of techniques for encoding and decoding such ancillary data are disclosed in U.S. Pat. No. 6,871,180, titled “Decoding of Information in Audio Signals,” issued Mar. 22, 2005, and is incorporated by reference in its entirety herein. Other suitable techniques for encoding data in audio data are disclosed in U.S. Pat. No. 7,640,141 to Ronald S. Kolessar and U.S. Pat. No. 5,764,763 to James M. Jensen, et al., which are incorporated by reference in their entirety herein. Other appropriate encoding techniques are disclosed in U.S. Pat. No. 5,579,124 to Aijala, et al., U.S. Pat. Nos. 5,574,962, 5,581,800 and U.S. Pat. No. 5,787,334 to Fardeau, et al., and U.S. Pat. No. 5,450,490 to Jensen, et al., each of which is assigned to the assignee of the present application and all of which are incorporated herein by reference in their entirety.

An audio signal which may be encoded with a plurality of code symbols is received at microphone 126, or via a direct link through audio circuitry 106. The received audio signal may be from streaming media, broadcast, otherwise communicated signal, or a signal reproduced from storage in a device. It may be a direct coupled or an acoustically coupled signal. From the following description in connection with the accompanying drawings, it will be appreciated that decoder 710 is capable of detecting codes in addition to those arranged in the formats disclosed hereinabove.

Alternately or in addition, processor(s) 103 can processes the frequency-domain audio data to extract a signature therefrom, i.e., data expressing information inherent to an audio signal, for use in identifying the audio signal or obtaining other information concerning the audio signal (such as a source or distribution path thereof). Suitable techniques for extracting signatures include those disclosed in U.S. Pat. No. 5,612,729 to Ellis, et al. and in U.S. Pat. No. 4,739,398 to Thomas, et al., both of which are incorporated herein by reference in their entireties. Still other suitable techniques are the subject of U.S. Pat. No. 2,662,168 to Scherbatskoy, U.S. Pat. No. 3,919,479 to Moon, et al., U.S. Pat. No. 4,697,209 to Kiewit, et al., U.S. Pat. No. 4,677,466 to Lert, et al., U.S. Pat. No. 5,512,933 to Wheatley, et al., U.S. Pat. No. 4,955,070 to Welsh, et al., U.S. Pat. No. 4,918,730 to Schulze, U.S. Pat. No. 4,843,562 to Kenyon, et al., U.S. Pat. No. 4,450,551 to Kenyon, et al., U.S. Pat. No. 4,230,990 to Lert, et al., U.S. Pat. No. 5,594,934 to Lu, et al., European Published Patent Application EP 0887958 to Bichsel, PCT Publication WO02/11123 to Wang, et al. and PCT publication WO91/11062 to Young, et al., all of which are incorporated herein by reference in their entireties. As discussed above, the code detection and/or signature extraction serve to identify and determine media exposure for the user of device 100.

Memory 118 may include high-speed random access memory (RAM) and may also include non-volatile memory, such as one or more magnetic disk storage devices, flash memory devices, or other non-volatile solid-state memory devices. Access to memory 118 by other components of the device 100, such as processor 103, decoder 110 and peripherals interface 104, may be controlled by the memory controller 102. Peripherals interface 104 couples the input and output peripherals of the device to the processor 103 and memory 118. The one or more processors 103 run or execute various software programs and/or sets of instructions stored in memory 108 to perform various functions for the device 100 and to process data. In some embodiments, the peripherals interface 104, processor(s) 103, decoder 110 and memory controller 102 may be implemented on a single chip, such as a chip 101. In some other embodiments, they may be implemented on separate chips.

The RF (radio frequency) circuitry 105 receives and sends RF signals, also called electromagnetic signals. The RF circuitry 105 converts electrical signals to/from electromagnetic signals and communicates with communications networks and other communications devices via the electromagnetic signals. The RF circuitry 105 may include well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 105 may communicate with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The wireless communication may use any of a plurality of communications standards, protocols and technologies, including but not limited to Global System for Mobile Communications (GSM), Enhanced Data GSM Environment (EDGE), high-speed downlink packet access (HSDPA), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), and/or Instant Messaging and Presence Service (IMPS)), and/or Short Message Service (SMS)), or any other suitable communication protocol, including communication protocols not yet developed as of the filing date of this document.

Audio circuitry 106, speaker 125, and microphone 126 provide an audio interface between a user and the device 100. Audio circuitry 106 may receive audio data from the peripherals interface 104, converts the audio data to an electrical signal, and transmits the electrical signal to speaker 125. The speaker 125 converts the electrical signal to human-audible sound waves. Audio circuitry 106 also receives electrical signals converted by the microphone 126 from sound waves, which may include encoded audio, described above. The audio circuitry 106 converts the electrical signal to audio data and transmits the audio data to the peripherals interface 104 for processing. Audio data may be retrieved from and/or transmitted to memory 708 and/or the RF circuitry 105 by peripherals interface 104. In some embodiments, audio circuitry 106 also includes a headset jack for providing an interface between the audio circuitry 106 and removable audio input/output peripherals, such as output-only headphones or a headset with both output (e.g., a headphone for one or both ears) and input (e.g., a microphone).

I/O subsystem 111 couples input/output peripherals on the device 100, such as touch screen 115 and other input/control devices 117, to the peripherals interface 104. The I/O subsystem 111 may include a display controller 112 and one or more input controllers 114 for other input or control devices. The one or more input controllers 114 receive/send electrical signals from/to other input or control devices 117. The other input/control devices 117 may include physical buttons (e.g., push buttons, rocker buttons, etc.), dials, slider switches, joysticks, click wheels, and so forth. In some alternate embodiments, input controller(s) 114 may be coupled to any (or none) of the following: a keyboard, infrared port, USB port, and a pointer device such as a mouse, an up/down button for volume control of the speaker 125 and/or the microphone 126. Touch screen 115 may also be used to implement virtual or soft buttons and one or more soft keyboards.

Touch screen 115 provides an input interface and an output interface between the device and a user. The display controller 112 receives and/or sends electrical signals from/to the touch screen 115. Touch screen 115 displays visual output to the user. The visual output may include graphics, text, icons, video, and any combination thereof (collectively termed “graphics”). In some embodiments, some or all of the visual output may correspond to user-interface objects. Touch screen 115 may have a touch-sensitive surface, sensor or set of sensors that accepts input from the user based on haptic and/or tactile contact. Touch screen 115 and display controller 112 (along with any associated modules and/or sets of instructions in memory 118) detect contact (and any movement or breaking of the contact) on the touch screen 115 and converts the detected contact into interaction with user-interface objects (e.g., one or more soft keys, icons, web pages or images) that are displayed on the touch screen. In an exemplary embodiment, a point of contact between a touch screen 115 and the user corresponds to a finger of the user. Touch screen 115 may use LCD (liquid crystal display) technology, or LPD (light emitting polymer display) technology, although other display technologies may be used in other embodiments. Touch screen 115 and display controller 112 may detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with a touch screen 112.

Device 100 may also include one or more sensors 116 such as optical sensors that comprise charge-coupled device (CCD) or complementary metal-oxide semiconductor (CMOS) phototransistors. The optical sensor may capture still images or video, where the sensor is operated in conjunction with touch screen display 115. Device 100 may also include one or more accelerometers 107, which may be operatively coupled to peripherals interface 104. Alternately, the accelerometer 107 may be coupled to an input controller 114 in the I/O subsystem 111. The accelerometer is preferably configured to output accelerometer data in the x, y, and z axes.

In some embodiments, the software components stored in memory 118 may include an operating system 119, a communication module 120, a contact/motion module 123, a text/graphics module 121, a Global Positioning System (GPS) module 122, and applications 124. Operating system 119 (e.g., Darwin, RTXC, LINUX, UNIX, OS X, WINDOWS, or an embedded operating system such as VxWorks) includes various software components and/or drivers for controlling and managing general system tasks (e.g., memory management, storage device control, power management, etc.) and facilitates communication between various hardware and software components. Communication module 120 facilitates communication with other devices over one or more external ports and also includes various software components for handling data received by the RF circuitry 105. An external port (e.g., Universal Serial Bus (USB), Firewire, etc.) may be provided and adapted for coupling directly to other devices or indirectly over a network (e.g., the Internet, wireless LAN, etc.

Contact/motion module 123 may detect contact with the touch screen 115 (in conjunction with the display controller 112) and other touch sensitive devices (e.g., a touchpad or physical click wheel). The contact/motion module 113 includes various software components for performing various operations related to detection of contact, such as determining if contact has occurred, determining if there is movement of the contact and tracking the movement across the touch screen 115, and determining if the contact has been broken (i.e., if the contact has ceased). Text/graphics module 121 includes various known software components for rendering and displaying graphics on the touch screen 115, including components for changing the intensity of graphics that are displayed. As used herein, the term “graphics” includes any object that can be displayed to a user, including without limitation text, web pages, icons (such as user-interface objects including soft keys), digital images, videos, animations and the like. Additionally, soft keyboards may be provided for entering text in various applications requiring text input. GPS module 122 determines the location of the device and provides this information for use in various applications. Applications 124 may include various modules, including address books/contact list, email, instant messaging, video conferencing, media player, widgets, instant messaging, camera/image management, and the like. Examples of other applications include word processing applications, JAVA-enabled applications, encryption, digital rights management, voice recognition, and voice replication.

Using a device such as the one disclosed in FIG. 1, a configuration may be arranged within applications module 124, or any other suitable module downloaded and/or stored in memory 118, to automatically generate screenshots on device 100. A screenshot, also known as screen dump, screen capture, screen grab, or print screen may be considered an image taken by the device to record the visible items displayed on the screen, monitor, television, or another visual output device. Under one embodiment, the digital image is produced using the operating system or software application running on the computer, resulting in a latent image that is converted and saved to an image file such as to .JPG, .BMP, or .GIF format. Once saved, the image file may be processed on the device 100 or transmitted externally for further processing.

As is known in the art, a digital image is a matrix (a two-dimensional array) of pixels. The value of each pixel is proportional to the brightness of the corresponding point in the scene; its value is often derived from the output of an A/D converter (103). The matrix of pixels, is typically square and may be thought of as an image as N×N m-bit pixels where N is the number of points along the axes and m controls the number of brightness values. Using m bits gives a range of 2^{m} values, ranging from 0 to 2^{m}−1. For example, if m is 8 this would provide brightness levels ranging between 0 and 255, which may be displayed as black and white, respectively, with shades of grey in between, similar to a greyscale image. Smaller values of m give fewer available levels reducing the available contrast in an image. Color images follow a similar configuration with regard to specify pixels' intensities. However, instead of using just one image plane, color images may be represented by three intensity components corresponding to red, green, and blue (RGB) although there other color schemes may be used as well. For example, the CMYK color model is defined by the components cyan, magenta, yellow and black. In any color mode, the pixel's color can be specified in two main ways. First, an integer value may be associated with each pixel, for use as an index to a table that stores the intensity of each color component. The index is used to recover the actual color from the table when the pixel is going to be displayed, or processed. In this scheme, the table is known as the image's palette and the display is said to be performed by color mapping.

As an alternative, color may be represented by using several image planes to store the color components of each pixel. This configuration is known as “true color” and represents an image more accurately by considering more colors. An advantageous format uses 8 bits for each of the three RGB components, resulting in 24-bit true color images and they can contain 16777 216 different colors simultaneously. Despite requiring significantly more memory, the image quality and the continuing reduction in cost of computer memory make this format a good alternative. Of course, a compression algorithm known in the art may be reduce memory requirements.

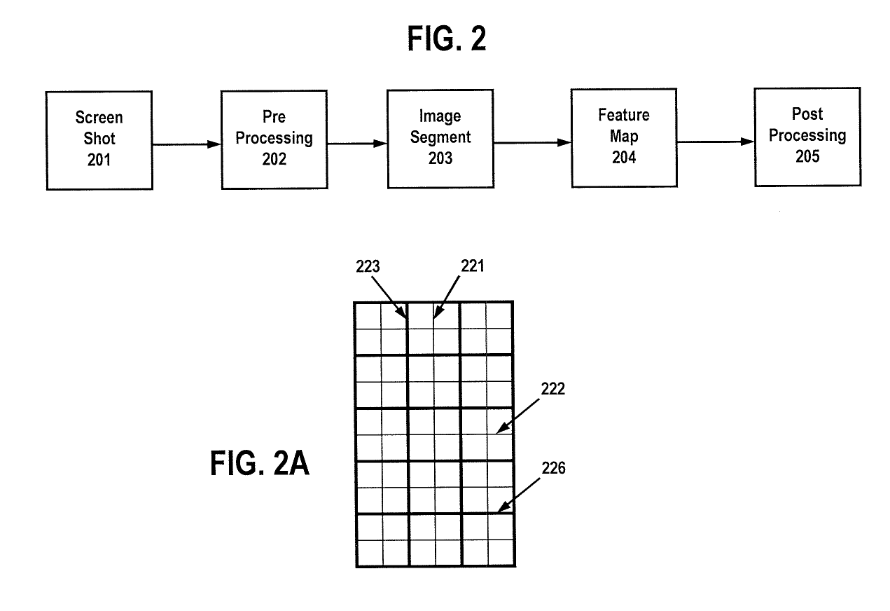

Turning to FIG. 2, an exemplary process for screenshot image processing is provided under one embodiment. In this example, the screenshot processing is in furtherance of detecting visual indicia of interest. More specifically, the example illustrates a process and method for detecting and identifying text in a screenshot. Currently, optical character recognition (OCR) technology is used to detect and identify text within a document or image. Under typical circumstances, conventional OCR processes are configured to detect black text on a white background. However, there may be numerous instances where text is interspersed, commingled, or mixed with graphical icons or images (e.g., click button, banner, name of artist in a media player, logo or icon, such as NFL, etc.). Many of the conventional OCR techniques are ill-equipped for processing text in these environments.

As a screenshot 201 (sometimes referred to herein as “image”) is captured on device 100, it may be subjected to preprocessing in 202, which may comprise binarizing, normalizing and/or enhancing the image. Image binarization may be performed to convert the image to a black and white image where a threshold value is assigned, and all pixels with values above this threshold are classified as white, and all other pixels as black. Under a preferred embodiment adaptive image binarization is performed to select an optimal threshold for each image area. Here, a value for the threshold is selected that separates an object from its background, indicating that the object has a different range of intensities to the background. The maximum likelihood of separation may be achieved by selecting a threshold that gives the best separation of classes, for all pixels in an image. One exemplary and advantageous technique for this is known as “Otsu binarization” which may automatically perform histogram shape-based image thresholding or the reduction of a graylevel image to a binary image. This technique operates by assuming that the image to be thresholded contains two classes of pixels or bi-modal histogram (e.g., foreground and background) then calculates the optimum threshold separating those two classes so that their combined spread (intra-class variance) is minimal. This technique may be extended to multi-level thresholding as well. It should be appreciated by those skilled in the art that other suitable binarization techniques are applicable as well.

Next image segmentation 203 is performed to partition the image into multiple segments (i.e., sets of pixels, or superpixels). During segmentation, pixels are grouped such that each pixel is assigned a value or label, and pixels with the same value/label are identified as sharing specific characteristics. As such, objects and boundaries (lines, curves, etc.) may be more readily located and identified. The result of image segmentation is a set of segments that collectively cover the entire image, or a set of contours extracted from the image (such as edge detection, discussed in greater detail below). Each of the pixels in a region would be deemed similar with respect to some characteristic or computed property, such as color, intensity, or texture. Adjacent regions would be deemed different with respect to the same characteristic(s).

In 204, feature extraction is performed to generate a feature map that may be used for text detection. In one exemplary embodiment, the feature extraction is based on edge detection, which is advantageous in that it tends to be immune to changes in overall illumination levels. As edge detection highlights image contrast (difference in intensity), the boundaries of features within an image may be emphasized. Essentially, the boundary of an object reflects a step change in the intensity levels, and the edge may be found at the position of the step change. To detect the edge position first order differentiation may be utilized in order to generate responses only when image signals change. A change in intensity may be determined by differencing adjacent points. Differencing horizontally adjacent points will detect vertical changes in intensity (horizontal edge-detector). Thus, a horizontal edge detector applied to an image 1 mg, the action of the horizontal edge-detector forms the difference between two horizontally adjacent points, as such detecting the vertical edges, Ex, as Ex_{x,y}=|Img_{x,y}−Img_{x+1,y}| for ∀xε1, N−1; yε1, N. To detect horizontal edges, a vertical edge-detector is used to difference vertically adjacent points. Accordingly, horizontal intensity changes may be detected, and thus detecting the horizontal edges, Ey, according to Ey_{x,y}=|Img_{x,y}−Img_{x,y+1}| for ∀xε1, N; yε1, N−1. Combining the two provides operator E that may detect horizontal and vertical edges together according to E_{x,y}=|Img_{x,y}−Img_{x+1,y}+Img_{x,y}−Img_{x,y+1}| which may be used to provide the coefficients of a differencing template which can be convolved with an image to detect all the edge points. The result of first order edge detection will typically be a peak where the rate of change of the original signal is greatest.

Some suitable first order edge detector operators include Prewitt, Sobel and Canny edge detectors. Canny edge detection is preferred as it provides optimal detection with minimal spurious responses, has good localization with minimal distance between detected and true edge position and provides a single response to eliminate multiple responses to a single edge. Briefly, Canny edge detection utilizes Gaussian filtering for image smoothing, where the coefficients of a derivative of a Gaussian template is calculated and the first order differentiation is combined with Gaussian smoothing. To mark an edge at the correct point, and to reduce multiple responses, the image may be convolved with an operator which gives the first derivative in a direction normal to the edge. The maximum of this function should be the peak of the edge data, where the gradient in the original image is sharpest, and hence the location of the edge. Non-maximum suppression may be used to locate the highest points in the edge magnitude data. Hysteresis thresholding may be used to set points to white once an upper threshold is exceeded and set to black when the lower threshold is reached.

In another embodiment, higher order derivatives, such as second order edge detection operators may be used. A second order derivative would be greatest where the rate of change of the signal is greatest and zero when the rate of change is constant (i.e., the peak of the first order derivative), which in turn would indicate a zero-crossing in the second order derivative, where it changes sign. Accordingly, a second order differentiation applied and zero-crossings may be detected in the second order information. Suitable operators for second order edge detection include Laplace operators or a Marr-Hildreth operator.

Once feature extraction is performed in 204, post-processing may be performed in 205 for additional (sharpening) filtering and to localize existing text regions for classification. Subsequently, character extraction may be performed. Turning to FIG. 2A, it can be seen in the simplified example that a screenshot image may be divided into regions bounded by a plurality of vertical borders 221 and horizontal borders 222. Larger regions may also be formed bounded by a plurality of vertical borders 223 and horizontal borders 224. These regions may be used under an embodiment for image analysis. Text regions in images have distinct characteristics from non-text regions such as high density gradient distribution, distinctive texture and structure, which can be used to differentiate text regions from non-text regions effectively. Utilizing region-based techniques, text detection and text localization may be effectively performed. For text detection, features of sampled regional windows are extracted to determine whether they contain text information. Then window grouping or clustering methods are employed to generate candidate text lines, which can be seen as coarse text localization. In some cases, post-processing such as image segmentation or profile projection analysis may be employed to localize texts further. Classification may be performed using support vector machines to obtain text based on the processed features.

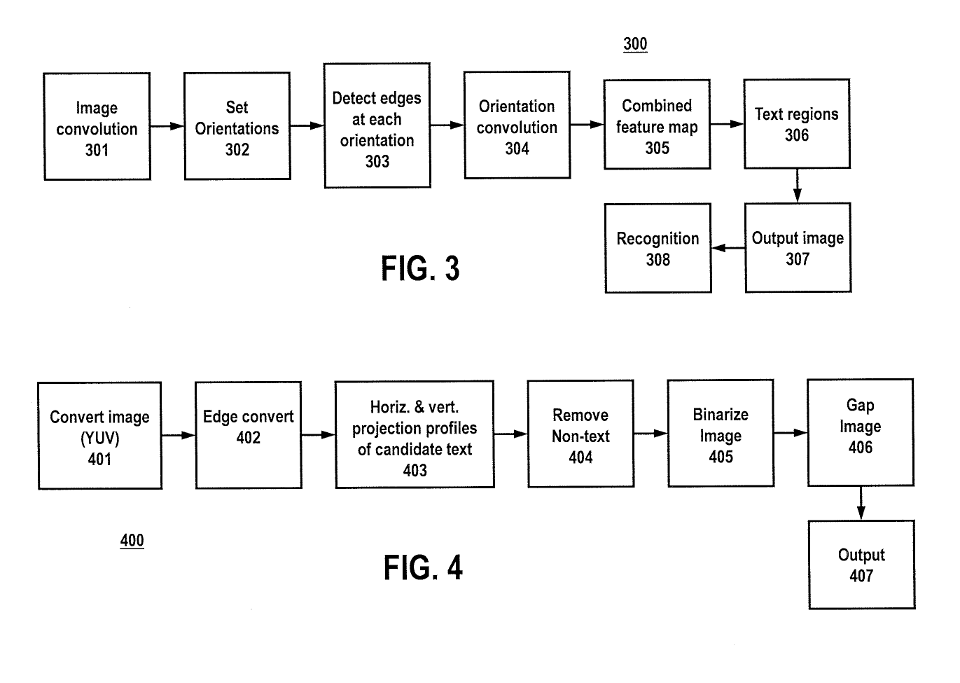

Turning to FIG. 3, an embodiment is disclosed for edge-based text region extraction and identification. As mentioned above, edges are a reliable feature of text detection regardless of color/intensity, layout, orientations, and so forth. Edge strength, density and orientation variance are three distinguishing characteristics of text, particularly when embedded in images, which can be used as main features for detecting text. Accordingly, the configuration of FIG. 3 may be advantageous for candidate text region detection, text region localization and character extraction. Starting from 301, a screenshot image may be processed by convolving the image with a Gaussian kernel and successively down-sampling each direction by a predetermined amount (e.g., ½). The feature map used for the processing is preferably a gray-scale image with the same size of the screenshot image, where the pixel intensity represents the possible presence of text.

Under a preferred embodiment, a magnitude of the second derivative of intensity is used as a measurement of edge strength to provide better detection of intensity peaks that normally characterize text in images. The edge density is calculated based on the average edge strength within a window. As text may exist in multiple orientations for a given screenshot, directional kernels may be utilized to set orientations 302 and detect edges at multiple orientations in 303. In one embodiment, four orientations (0°, 45°, 90°, 135°) are used to evaluate the variance of orientations, where 0° denotes horizontal direction, 90° denotes vertical direction, and 45° and 135° are the two diagonal directions, respectively. Each image may be convolved in the Gaussian filter with each orientation. A convolution operation with a compass operator will result in four oriented edge intensity images containing the necessary properties of edges required for processing.

Preferably, multiscale images are produced for edge detection using Gaussian pyramids which successively low-pass filter and down-sample the original image reducing image in both vertical and horizontal directions. Generated multiscale images may be simultaneously processed by a compass operator as individual inputs. As regions containing text will have significantly higher values of average edge density, strength and variance of orientations than those of non-text regions, these characteristics may be used to generate a feature map 305 which suppresses the false regions and enhances true candidate text regions. The feature map (fₘₐₚ) may be generated according to

$${f}_{map} ( i , f ) = {⊕}_{x = 0}^{n} {Σ}_{θ} N \{ {\sum }_{x = - c}^{c} {\sum }_{y = - c}^{c} E ( s , θ , i + x , j + y ) \times W ( i , j ) \}$$

where ⊕ is an across-scale addition operation employing a scale fusion and n is the highest level of scale determined by the resolution of the screenshot image. θ refers to the different orientations used (0°, 45°, 90°, 135°) and N is a normalization operation. (i, j) are coordinates of an image pixel, while W(i, j) is the weight for pixel (i, j), whose value is determined by the number of edge orientations within a window, whose window size is determined by a constant c. Generally, the more orientations a window has, the larger weight the center pixel has. By employing the non linear weight mapping described above, text regions may be more readily detected from non-text regions.

In 306, text region localization is performed by processing clusters found in the feature map. These clusters may be found according to threshold intensities found in the feature map. Global thresholding may be used to highlight regions having a high probability of text, where a morphological dilation operation may be used to connect close regions together (thus signifying the potential presence of a letter/word, or “text blobs”) while isolating regions farther away for independent grouping (i.e., signifying other potential letters/words). Generally speaking, a dilation operation expands or enhances a region of interest using a structural element of a specific shape and/or size. The dilation process is executed by using a larger structural element (e.g., 7×7) in order to enhance the regions that lie close to each other. The resulting image after dilation may still include some non-text regions or noise that should be eliminated. Area based filtering is carried out to eliminate noise blobs by filtering all the very small isolated blobs and blobs having widths that are much smaller than corresponding heights. The retained blobs may be enclosed in boundary boxes, where multiple pairs of coordinates of the boundary boxes are determined by the maximum and minimum coordinates of the top, bottom, left and right points of the corresponding blobs. In order to avoid missing those character pixels which lie near or outside of the initial boundary, width and height of the boundary box may be padded by small amounts.

The resulting output image 307 will typically comprise extracted accurate binary characters from the localized text regions for OCR recognition in 308, where the text would appear as white character pixels in a black background. Sub-images for the text are extracted according to the boundary boxes according to a thresholding algorithm that segments the text regions.

Another embodiment directed to connected component based text region extraction is illustrated in FIG. 4. Generally, screenshot color images are converted to grayscale images, and an edge image is generated using a contrast segmentation algorithm, which in turn uses the contrast of the character contour pixels to their neighboring pixels. This is followed by the analysis of the horizontal projection of the edge image in order to localize the possible text areas. After applying several heuristics to enhance the resulting image created in the previous step, an output image is generated that shows the text appearing in the input image with a simplified background. These images would then be used for OCR recognition. In a preferred embodiment, the software for the configuration in FIG. 4 may be written in JAVA to allow the code to run in parallel on possibly heterogeneous networked computing platforms.

Continuing with FIG. 4, a received screenshot image, if necessary, is first converted to a YUV color space 401, where Y represents the luminance and U and V are the chrominance (color) components. Using Y, luminance value thresholding is applied to spread luminance values throughout the image and increase the contrast between the potential text regions and the rest of the image. The output at this point will be a grey image. In 402, edge detection is performed to covert the grey image to an edge image and identify regions where text may be present. Since character contours have high contrast to their local neighbors, all character pixels as well as some non-character pixels showing high local color contrast are registered in the edge image. Horizontal and vertical projection profiles of candidate text regions are computed using a histogram having an appropriate threshold value. The value of each pixel of the original image is replaced by the largest difference between itself and its neighbors, preferably in the horizontal, vertical and diagonal directions, and the contrast between edges may be increased by means of a convolution with an appropriate mask or sharpening filter.

In 403, a horizontal projection profile of the edge image is analyzed in order to locate potential text areas, indicated by high peaks in horizontal projection. First, a histogram is computed, using the number of pixels in each line of the edge image exceeding a given value. In subsequent processing, the local maxima are calculated by the histogram and a plurality of thresholds may be used to find the local maxima. A line of the image is accepted as a text line candidate if either it contains a sufficient number of sharp edges, or the difference between the edge pixels in one line to its previous line is bigger than a threshold. The thresholds may be fixed so that a text region containing several texts aligned horizontally (with already-defined y-coordinates) may be isolated. Subsequently, the x-coordinates of the neighboring text region (left/right, top/bottom) may be defined and exact coordinates for each of the detected areas are used to create bounding boxes. Only regions falling within threshold limits are considered candidates for text. Adaptive threshold values may be calculated for vertical and horizontal projections, where regions falling within the threshold limits are only considered as candidates for text. The value of vertical threshold is selected to eliminate non-text regions having strong vertical orientations, while the horizontal thresholds are selected to eliminate non-text regions or regions having long edges in the horizontal orientation.

In 404, enhancement and segmentation of text regions is performed to remove non-text. First, geometric properties of the text characters like the possible height, width, width-to-height ratio are used to discard those regions whose geometric features do not fall into the predefined ranges of values. All remaining text candidates further processed in order to generate the text image where detected text appears on a simplified background. A binary edge image is generated from the edge image, erasing all pixels outside the predefined text boxes and then binarizing it 405. This is followed by the process of gap filling 406. If one white pixel on the binary edge image is surrounded by two black pixels in horizontal, vertical or diagonal direction, then it is also filled with black. The gap image is used as a reference image to refine the localization of the detected text candidates. Text segmentation is then performed to extract text candidates from the gray image. Then, the segmentation process concludes with a procedure which enhances text to background contrast on the text image, resulting in an output image 407 that is suitable for OCR recognition. It should be appreciated by those skilled in the art that the embodiments of FIGS. 3 and 4 may also be combined to achieve advantageous text recognition as well.

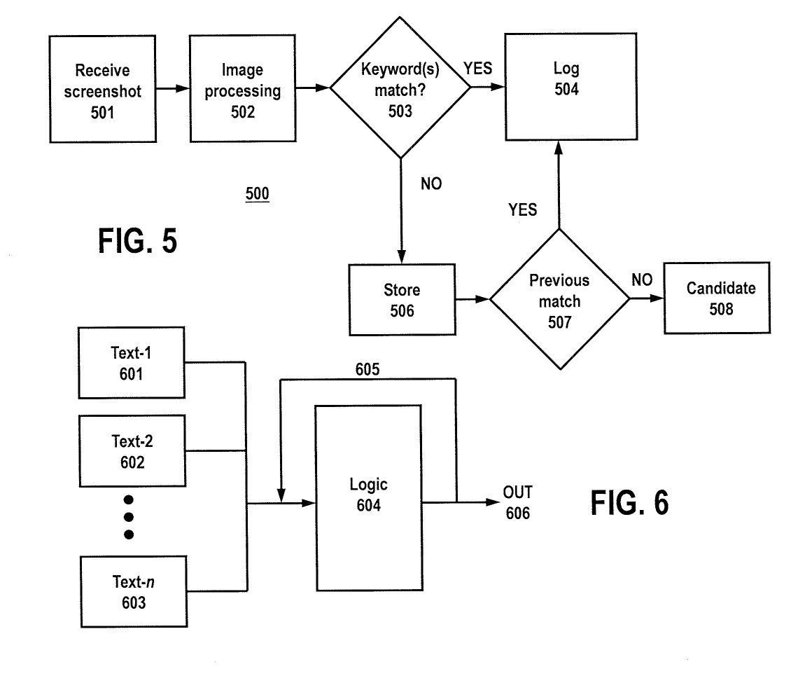

Turning now to FIG. 5, an exemplary embodiment is illustrated where any of the text recognition techniques described above may be utilized to determine device usage and/or media exposure. Under a preferred embodiment, a user device, such as a cell phone, tablet, laptop, personal computer and the like is equipped with software enabling the device to automatically take screenshots at predetermined times. The actual time period for taking screenshots may be determined by the processing/storage capabilities of the device. Thus, devices such as cell phones may be best suited for longer time periods between screenshots, while devices such as personal computers may be suited for shorter time periods. As each screenshot is generated, it is preferably time stamped and stored on the device. Alternately, each screenshot may be time stamped and automatically transmitted, via wired or wireless connections known in the art, to a central site without being stored on the device. In another embodiment, screenshots collected over a given time period may be grouped and transmitted together in an original or compressed format. In yet another embodiment, screenshots may also be triggered through the activation of an event, such as an activation of a screen or application.

Also, depending on the processing/storage capabilities of the device, the generation of screenshots and processing of screenshots to detect text may be divided between the device and a remote server. Thus, screenshots transmitted from a device would be received at a server and processed for text detection. Of course, if sufficient processing/storage exists on the device, the screenshots and text-based processing may occur all on the device.

In the embodiment of FIG. 5, the illustration will be described from the perspective of screenshots received at a server. After the screenshots are received 501, image processing 502 is performed to detect and extract text, discussed in greater detail above. In step 503, the extracted text (e.g., alphanumeric symbols) is compared to a database of keywords to detect if there is a match. For example, a library of keywords (e.g., in an SQL database) may contain words of interest (e.g., ESPN, Pandora, etc.) for matching. If a match exists, the device usage is logged 504 with respect to that keyword. Additionally, multiple keywords may be linked to indicate device usage and/or media usage. For example, locating words “home”+“connect”+“discover”+“me” on a bottom location of the screen would be indicative of a user actively using a Twitter account. In another example, detecting the presence of time-based text (e.g., “0:00”, “3:23”) would be indicative of a media player being used, in which case the media player usage is logged. Moreover, the detection of media player usage via text could advantageously facilitate the further logging of text that is indicative of the media content being played (e.g., artist, song, file name). Using logic-based techniques known in the art, the media player usage and media content text may be linked together, allowing audience measurement entities to detect the usage of a media player along with a successive string of content that was being played.

However, if a match is not detected in 503, the extracted word is preferably stored in 506 and compared to any previously unmatched text in 507. If no match exists, the text is stored in 508 as unclassified text (i.e., previously unmatched text), which may be used for subsequent match processing. If a match does exist, the text is logged in 504. This configuration may be advantageous for instituting text learning in the system, particularly when initial matches do not indicate a particular device usage or media exposure. Under one embodiment, unclassified matches may be labeled as such in the system, and post processing techniques, using probabilistic or heuristic techniques, may be used to form new classifications automatically. In an alternate embodiment, the unclassified matches may be analyzed by the system operator and manually assigned new classification(s) for future processing. Such a configuration could advantageously allow system operators to maintain and update text matching operations as the system requirements grow.

Turning to FIG. 6, a simplified exemplary configuration is shown for arranging text for matching. Here, a plurality of texts (Text-1 601 -Text-n 603) are input into logic 604 to link them in a desired manner for matching purposes. In one embodiment, the logic links the text according to Boolean operators, so that text extracted from incoming screenshots would be classified according to matches meeting the operators. Furthermore, a feedback loop 605 may be utilized for nesting text (e.g., ((Text-1 AND Text-2) AND Text-3)) for more sophisticated matching operations.

It can be appreciated by those skilled in the art that the present disclosure provides and elegant and simplified manner for determining device usage and/or media exposure and generating reports therefrom. Under one embodiment, reports may comprise a listing of device usage and/or media exposure relating to the specific device. The reports are preferably tabulated in a manner known in the art. By utilizing screenshots, there is no need to link device detection and/or media exposure collection software directly to the operating system and/or software applications. Furthermore, as screenshots will typically be provided in a universal format (e.g., JPEG, GIF, etc.), processing may occur independently of operating systems of devices being used. Moreover, since text detection has the ability to provide a larger, and potentially better dataset, more robust device usage and/or media exposure data me be achieved.

While at least one example embodiment has been presented in the foregoing detailed description, it should be appreciated that a vast number of variations exist. It should also be appreciated that the example embodiment or embodiments described herein are not intended to limit the scope, applicability, or configuration of the invention in any way. Rather, the foregoing detailed description will provide those skilled in the art with a convenient and edifying road map for implementing the described embodiment or embodiments. It should be understood that various changes can be made in the function and arrangement of elements without departing from the scope of the invention and the legal equivalents thereof.

What is claimed is:

1. A computer-implemented method for monitoring at least one of usage and media exposure on a processing device, comprising the steps of:
receiving a screenshot image of the processing device;
processing the screenshot image via a processing apparatus to detect at least one text region in the screenshot image and to extract text from the at least one text region;
comparing the extracted text, via the processing apparatus, with stored text to determine if a match exists, wherein the stored text is associated with a processing device characteristic; and
identifying at least one of a specific usage and media exposure via the processing apparatus if a match is determined to exist.

2. The computer-implemented method of claim 1, wherein processing the screenshot image comprises binarizing and segmenting the screenshot image to generate a feature map.

3. The computer-implemented method of claim 2, wherein processing the screenshot image comprises extracting characteristics from the feature map.

4. The computer-implemented method of claim 3, wherein processing the screenshot image comprises identifying a presence of text in the at least one text region based on the characteristics extracted from the feature map.

5. The computer-implemented method of claim 1, wherein the processing device characteristic comprises at least one of (i) a manner of device usage, (ii) an application being used or accessed on the processing device, and (iii) data relating to media being consumed on the processing device.

6. The computer-implemented method of claim 1, wherein the processing device is one of a cell phone, tablet, laptop and personal computer.

7. The computer-implemented method of claim 1, wherein the stored text comprises a plurality of alphanumeric symbols, where at least one of the plurality of alphanumeric symbols are linked to at least another one of the plurality of alphanumeric symbols.

8. A computer program product, comprising a computer usable medium having a computer readable program code embodied therein, said computer readable program code adapted to be executed to implement a method for method for monitoring at least one of usage and media exposure on a processing device, said method comprising:
receiving a screenshot image of the processing device;
processing the screenshot image via a processing apparatus to detect at least one text region in the screenshot image and to extract text from the at least one text region;
comparing the extracted text, via the processing apparatus, with stored text to determine if a match exists, wherein the stored text is associated with a processing device characteristic; and
identifying at least one of a specific usage and media exposure via the processing apparatus if a match is determined to exist.

9. The computer program product of claim 8, wherein processing the screenshot image comprises binarizing and segmenting the screenshot image to generate a feature map.

10. The computer program product of claim 9, wherein processing the screenshot image comprises extracting characteristics from the feature map.

11. The computer program product of claim 10, wherein processing the screenshot image comprises identifying a presence of text in the at least one text region based on the characteristics extracted from the feature map.

12. The computer program product of claim 8, wherein the processing device characteristic comprises at least one of (i) a manner of device usage, (ii) an application being used or accessed on the processing device, and (iii) data relating to media being consumed on the processing device.

13. The computer program product of claim 8, wherein the processing device is one of a cell phone, tablet, laptop and personal computer.

14. The computer program product of claim 8, wherein the stored text comprises a plurality of alphanumeric symbols, where at least one of the plurality of alphanumeric symbols are linked to at least another one of the plurality of alphanumeric symbols.

15. A computer-implemented method for monitoring at least one of usage and media exposure on a processing device, comprising the steps of:
generating a feature map via a processing apparatus from a screenshot image of the processing device;
extracting image characteristics via the processing apparatus from the feature map;
detecting at least one text region via the processing apparatus based on the extracted characteristic;
extracting text from the at least one text region via the processing apparatus;
comparing the extracted text, via the processing apparatus, with stored text to determine if a match exists, wherein the stored text is associated with a processing device characteristic; and
identifying at least one of a specific processor device usage and media exposure via the processing apparatus if a match is determined to exist.

16. The computer-implemented method of claim 15, wherein the feature map comprises a binarized and segmented screenshot image.

17. The computer-implemented method of claim 15, wherein the processing device characteristic comprises at least one of (i) a manner of device usage, (ii) an application being used or accessed on the processing device, and (iii) data relating to media being consumed on the processing device.

18. The computer-implemented method of claim 15, wherein the processing device is one of a cell phone, tablet, laptop and personal computer.

19. The computer-implemented method of claim 15, wherein the stored text comprises a plurality of alphanumeric symbols, where at least one of the plurality of alphanumeric symbols are linked to at least another one of the plurality of alphanumeric symbols.

20. The computer-implemented method of claim 15, further comprising the step of generating a report comprising data relating to the specific processor device usage and media exposure.
